(19) United States
(12) Patent Application Publication
(10) Pub. No.: US 2008/0102165 A1
(43) Pub. Date: May 1, 2008

(54) Extruded Protein Compositions

(75) Inventors: Luping L. Ning, St. Louis, MO (US); Eugene A. Dust, St. Peters, MO (US); Phillip I. Yakubu, St. Louis, MO (US)

Correspondence Address: Solae, LLC, 4300 Duncan Avenue, Legal Department E4, St. Louis, MO, 63110, US

(73) Assignee: SOLAE, LLC, St. Louis, MO (US)

(21) Appl. No.: 11/864,852

(22) Filed: Sep. 28, 2007

Related U.S. Application Data
(60) Provisional application No. 60/827,298, filed on Sep. 28, 2006.

(51) Int. Cl. A23J 3/00; A23J 1/00; A23J 3/26; A23L 1/03

(52) U.S. Cl. 426/72; 426/311; 426/448; 426/534; 426/541; 426/564; 426/656

(57) ABSTRACT

The invention provides a puffable extruded protein composition. In addition, food products containing a puffable extruded protein composition are provided. The invention further provides a process for producing a puffable extruded protein composition.

### CROSS REFERENCE TO RELATED APPLICATIONS

This application claims priority from Provisional Application Ser. No. 60/827,298 filed on Sep. 28, 2006, which is hereby incorporated by reference in its entirety.

### FIELD OF THE INVENTION

The present invention provides an extruded protein composition and a process for producing the extruded protein composition. In addition, the invention provides food products containing the extruded protein composition.

### BACKGROUND OF THE INVENTION

Much effort and many resources have been applied in the food industry to provide snack products that are both nutritious and convenient. Many successes have been achieved in non-snack foods but nutritious snack foods have been more difficult to achieve. Typically, cereal grain based crisp snack foods such as chips are generally cooked at high temperatures, which can adversely affect the nutritional value of the ingredients. Additionally, the cooking processes generally used for crisp snack foods, particularly cereal grain based foods, is frying, which can result in a high level of fat intake for the consumer with its resulting nutritional problems. Further, in frying processes, sometimes it is difficult to control the amount of fat uptake into the products or keep the fat uptake at a low level while still providing a fully cooked and crisp product. Moreover, these products are typically high in starch and low in protein.

Alternative cooking methods have been provided for snack items, but many do not have the same appeal as fried products. Baked products have not met with the same success as their fried counterparts even with the drawbacks of the fried products. Typically, such foods have a high density and consumers tend to overeat such products since there visually appears to be very little product intake during the eating occasion. Low-density snack products have been provided such as popcorn and cheese curls to provide a large volume, low nutrient snack. However, some of these products tend to be high in fat and/or low in protein content.

One problem encountered in making high protein items is the formation of fiber bundles, which is believed to be an interconnecting of protein molecules. Such formation of fiber bundles has resulted in a dense, chewy, and tough product instead of a crisp, crunchy, and frangible food product as snack foods typically are.

Yet another problem with high protein products is the dense cell formation due to the interconnecting of protein molecules. This in turn makes the desired molten product chewy and tough when texturized or hard and brittle when not texturized.

There is thus a need for an improved crispy snack product having a high protein yet low fat content, which provides nutritional benefits to humans.

### SUMMARY OF THE INVENTION

One aspect of the present invention encompasses an extruded protein composition. Typically, the extruded protein composition comprises a density of between about 0.3 g/cm³ to about 1.5 g/cm³ and protein matrices that have a substantially closed cell structure.

Another aspect of the invention encompasses a food product. Generally, the food product comprises an extruded protein composition and a food ingredient. The extruded protein composition generally comprises a density of between about 0.3 g/cm³ to about 1.5 g/cm³ and protein matrices that have a substantially closed cell structure.

A further aspect of the invention encompasses a puffable popcorn-like food product. The popcorn-like food product comprises an extruded protein composition. The extruded protein composition typically comprises a density of between about 0.3 g/cm³ to about 1.5 g/cm³ and protein matrices that have a substantially closed cell structure.

Yet another aspect of the invention provides a process for producing an extruded protein composition. Typically, the process comprises combining a protein-containing material with a starch to form a mixture. The mixture is extruded under conditions of elevated temperature and pressure to form the extruded protein composition comprising a density of between about 0.3 g/cm³ to about 1.5 g/cm³ and protein matrices that have a substantially closed cell structure.

Other aspects and features of the invention are described in more detail below.

### FIGURE LEGENDS

The application file contains at least one photograph executed in color. Copies of this patent application publication with color photographs will be provided by the Office upon request and payment of the necessary fee.

FIG. 1 depicts a photographic image of a micrograph showing an extruded protein composition of the invention comprising protein matrices that have a substantially closed cell structure. The extruded protein composition does not include added fiber.

FIG. 2 depicts a photographic image of a micrograph showing an extruded protein composition of the invention comprising protein matrices that have a substantially closed cell structure. The extruded protein composition includes added fiber.

FIG. 3 depicts a photographic image of a micrograph showing an extruded protein composition of the invention that has been puffed or expanded by heating. The puffed or expanded extruded protein composition does not include added fiber and has protein matrices that have a substantially open cell structure.

FIG. 4 depicts a photographic image of a micrograph showing an extruded protein composition of the invention that has been puffed or expanded by heating. The puffed or expanded extruded protein composition includes added fiber and has protein matrices that have a substantially open cell structure.

### DETAILED DESCRIPTION OF THE INVENTION

The present invention provides an extruded protein composition and processes for producing the extruded protein composition. In addition, the invention provides food products comprising an extruded protein composition. Typically, the extruded protein composition will comprise a density of at least about 0.3 g/cm³ and have protein matrices that have a substantially closed cell structure. The process of the invention provides a means to produce an extruded protein composition. In the process, a protein-containing material is combined with a starch to form a mixture. The mixture is extruded under conditions of elevated temperature and pressure to form an extruded protein composition. Because the extruded protein compositions are relatively high in protein and low in fat, they may be added to a variety of food products to enhance both the food products taste and nutritional content.

Extruded Protein Composition

The extruded protein composition of the invention comprises protein matrices that have a substantially closed cell structure, as described in more detail in I (g) below. In an exemplary embodiment, the extruded protein composition is an extrudate that has been subjected to the extrusion process detailed in I (e) below. As will be appreciated by the skilled artisan, a variety of ingredients may be combined to produce a pre-mix, which is extruded to create the extruded protein compositions of the invention. Suitable ingredients for the pre-mix are detailed below.

Protein-Containing Material

A variety of ingredients that contain protein may be utilized in an extrusion process to produce an extruded protein composition. While ingredients comprising proteins derived from plants are typically used, it is also envisioned that proteins derived from other sources, such as animal sources, may be utilized without departing from the scope of the invention. For example, a dairy protein selected from the group consisting of casein, caseinates, whey protein, milk protein concentrate, milk protein isolate, and mixtures thereof may be utilized. In an exemplary embodiment, the dairy protein is whey protein. By way of further example, an egg protein selected from the group consisting of ovalbumin, ovoglobulin, ovomucin, ovomucoid, ovotransferrin, ovovitella, ovovitellin, albumin globulin, vitellin, and mixtures thereof may be utilized.

It is envisioned that other ingredient types in addition to proteins may be utilized. Not limiting examples of such ingredients include sugars, starches, oligosaccharides, soy fiber and other dietary fibers, gluten, and mixtures thereof.

Irrespective of its source or nutrient classification, the ingredients utilized in the extrusion process are typically capable of forming extrudates having protein matrices that have a substantially closed cell structure and a density of at least 0.3 g/cm³. Suitable examples of such ingredients are detailed more fully below.

Plant Protein Materials

In an exemplary embodiment, at least one ingredient derived from a plant will be utilized to form the protein-containing materials. Generally speaking, the ingredient will comprise a protein. The amount of protein present in the ingredient(s) utilized can and will vary depending upon the application. For example, the amount of protein present in the ingredient(s) utilized may range from about 1% to about 90% by weight. In another embodiment, the amount of protein present in the ingredient(s) utilized may range from about 5% to about 75% by weight. In an additional embodiment, the amount of protein present in the ingredient(s) utilized may range from about 10% to about 60% by weight. In a further embodiment, the amount of protein present in the ingredient(s) utilized for the extruded protein composition may range from about 15% to about 55% by weight. In a further embodiment, the amount of protein present in the ingredient(s) utilized for the extruded protein composition may range from about 20% to about 50% by weight.

The ingredient(s) utilized in extrusion may be derived from a variety of suitable plants. By way of non-limiting example, suitable plants include legumes, oilseeds, cereal grains, tubers, pseudograins, and mixtures thereof. Generally, any legume, oilseed, cereal grain, tuber or pseudograin known in the art can be used in the current application. Legumes are crops with seeds that are typically high in protein, such as soybean (also considered an oilseed), peanut, lentils, favas, peas, lupin, channa (garbanzo), and various dry edible beans. Oilseeds are crops that are primarily grown for their oil content, including among others, soybean, sunflower, safflower, flax, canola, and rape. Cereal grains are the seeds of grasses which produce dry one-seeded fruits known as a kernel or grain. Cereal grains include rice, corn, wheat, barley, oats, spelt, rye, and sorghum. Tubers are crops where a primary harvested component is the root, such as potatoes, tapioca, beets, carrots, arrowroot, and cassava. Pseudograins are crops that share many characteristics of cereal grains, but are not technically cereal grains, since they are not grasses. Examples of pseudograins include buckwheat, amaranth, and quinoa.

In one embodiment, the ingredients are isolated from wheat and soybeans. In another exemplary embodiment, the ingredients are isolated from soybeans. Suitable wheat derived protein-containing ingredients include wheat gluten, wheat flour, and mixtures thereof. An example of a commercially available wheat gluten that may be utilized in the invention is Gem of the West Vital Wheat Gluten, either regular or organic, available from Manildra Milling (Shawnee Mission, Kans.). Suitable soybean derived protein-containing ingredients (“soy protein material”) include soy protein isolate, soy protein concentration, soy protein flour, and mixtures thereof, each of which are detailed below.

In each of the foregoing embodiments, the soybean material may be combined with one or more ingredients selected from the group consisting of starch, flour, gluten, fiber, and mixtures thereof.

Suitable examples of protein-containing material isolated from a variety of sources are detailed in Table A, which shows various combinations. Organic versions of these proteins may also be used in the invention.

TABLE A
Protein Combinations

| First protein source | Second ingredient |
|---|---|
| Soybean | Wheat |
| Soybean | Dairy |
| Soybean | Egg |
| Soybean | Corn |
| Soybean | Rice |
| Soybean | Barley |
| Soybean | Sorghum |
| Soybean | Oat |
| Soybean | Millet |
| Soybean | Rye |
| Soybean | Triticale |
| Soybean | Buckwheat |
| Soybean | Pea |
| Soybean | Peanut |
| Soybean | Lentil |
| Soybean | Lupin |
| Soybean | channa (garbonzo) |
| Soybean | rapeseed (canola) |
| Soybean | Cassava |
| Soybean | Sunflower |
| Soybean | Potato |
| Soybean | Tapioca |
| Soybean | arrowroot |
| Soybean | amaranth |
| Soybean | wheat and dairy |
| Soybean | wheat and egg |
| Soybean | wheat and corn |
| Soybean | wheat and rice |
| Soybean | wheat and barley |
| Soybean | wheat and sorghum |
| Soybean | wheat and oat |
| Soybean | wheat and millet |
| Soybean | wheat and rye |
| Soybean | wheat and triticale |
| Soybean | wheat and buckwheat |
| Soybean | wheat and pea |
| Soybean | wheat and peanut |
| Soybean | wheat and lentil |
| Soybean | wheat and lupin |
| Soybean | wheat and channa (garbonzo) |
| Soybean | wheat and rapeseed (canola) |
| Soybean | wheat and cassava |
| Soybean | wheat and sunflower |
| Soybean | wheat and potato |
| Soybean | wheat and tapioca |
| Soybean | wheat and arrowroot |
| Soybean | wheat and amaranth |
| Soybean | corn and wheat |
| Soybean | corn and dairy |
| Soybean | corn and egg |
| Soybean | corn and rice |
| Soybean | corn and barley |
| Soybean | corn and sorghum |
| Soybean | corn and oat |
| Soybean | corn and millet |
| Soybean | corn and rye |
| Soybean | corn and triticale |
| Soybean | corn and buckwheat |
| Soybean | corn and pea |
| Soybean | corn and peanut |
| Soybean | corn and lentil |
| Soybean | corn and lupin |
| Soybean | corn and channa (garbonzo) |
| Soybean | corn and rapeseed (canola) |
| Soybean | corn and cassava |
| Soybean | corn and sunflower |
| Soybean | corn and potato |
| Soybean | corn and tapioca |
| Soybean | corn and arrowroot |
| Soybean | corn and amaranth |

(ii). Soy Protein Materials

In an exemplary embodiment, as detailed above, soy protein isolate, soy protein concentrate, soy flour, and mixtures thereof may be utilized in the protein composition. The soy protein materials may be derived from whole soybeans in accordance with methods generally known in the art. The whole soybean may be standard soybeans (i.e., non-genetically modified soybeans), commoditized soybeans, hybridized soybeans, genetically modified soybeans, and combinations thereof.

Generally, when soy isolate is used, an isolate is preferably selected that is a highly hydrolyzed soy protein isolate. In certain embodiments, highly hydrolyzed soy protein isolates, may be used in combination with other soy protein isolates provided that the highly hydrolyzed soy protein isolate content of the combined soy protein isolates is generally between about 35% to about 75% of the combined soy protein isolates, by weight. Examples of soy protein isolates that are useful in the present invention are commercially available, for example, from Solae, LLC (St. Louis, Mo.), and include SUPRO® 500E, SUPRO® 620, SUPRO® 545, SUPRO® 8000, SUPRO® 710, SUPRO® 313, and SUPRO® 670.

Alternatively, soy protein concentrate or soy flour may be blended with the soy protein isolate to substitute for a portion of the soy protein isolate as a source of soy protein material. Typically, if a soy protein concentrate is substituted for a portion of the soy protein isolate, the soy protein concentrate is substituted for up to about 40% of the soy protein isolate by weight. Examples of suitable soy protein concentrates useful in the invention include Procon 2100, Alpha 12, Alpha 5800, and ProMax 70N which are commercially available from Solae, LLC (St. Louis, Mo.). If a soy flour is substituted for a portion of the soy protein isolate, the soy flour is substituted for up to about 35% of the soy protein isolate by weight.

In another embodiment, soy protein concentrate replaces the soy protein isolate as the source of soy protein material. Examples of suitable soy protein concentrates useful in the invention include Procon 2100, Alpha 12, Alpha 5800, and ProMax 70N which are commercially available from Solae, LLC (St. Louis, Mo.). When the soy protein material is soy protein concentrate, the addition of starch is optional.

Any fiber known in the art that will work in the application can be used as the fiber source. Soy cotyledon fiber may optionally be utilized as a fiber source. Typically, suitable soy cotyledon fiber will effectively bind water when the mixture of soy protein and soy cotyledon fiber is extruded. In this context, “effectively bind water” generally means that the soy cotyledon fiber has a water holding capacity of at least 5.0 to about 8.0 grams of water per gram of soy cotyledon fiber, and preferably the soy cotyledon fiber has a water holding capacity of at least about 6.0 to about 8.0 grams of water per gram of soy cotyledon fiber. Soy cotyledon fiber may generally be present in the soy protein material in an amount ranging from about 1% to about 80%, preferably from about 1.5% to about 40% and most preferably, at from about 5% to about 25% by weight on a moisture free basis. Suitable soy cotyledon fiber is commercially available. For example, FIBRIM® 1260 and FIBRIM® 2000 are soy cotyledon fiber materials that are commercially available from Solae, LLC (St. Louis, Mo.).

Carbohydrate Source

The protein-containing material detailed in I (a) is typically combined with at least one carbohydrate source. Generally speaking, the carbohydrate source is starch, cereal flour, pregelatinized starch, or a modified food starch. Suitable starches are known in the art, and may include starches derived from vegetables (including legumes) or grains. Non-limiting examples of suitable starches may include starch derived from corn, potato, rice, wheat, arrowroot, guar gum, locust bean, tapioca, arracacha, buckwheat, banana, barley, cassaya, konjac, kudzu, oca, sago, sorghum, sweet potato, taro, yams, fruit, vegetables, tubers, legumes, cereal grains, pseudograins, and mixtures thereof. Edible legumes, such as favas, lentils, and peas, are rich in suitable starches. Suitable starches can also include the wholegrain flours of these ingredients. Tapioca is the preferred starch for applications requiring a high degree of expansion.

Regardless of the specific starch used, the percentage of starch utilized in the extruded protein composition typically determines, in part, its texture when it is expanded. Generally speaking, a high percentage of starch will typically result in an extruded protein composition having a crispy texture in lieu of being chewy, dense, and hard. Conversely, a low percentage of starch typically yields products that are chewy, dense, and hard in lieu of being crispy. As such, the amount of starch present in the extruded protein composition can and will vary depending upon the desired texture of the product. For example, the amount of starch present in the extruded protein composition may range from about 1% to about 90% by weight. In another embodiment, the amount of starch present in the ingredient(s) utilized for the extruded protein composition may range from about 5% to about 60% by weight. In an additional embodiment, the amount of starch present in the ingredient(s) utilized for the extruded protein composition may range from about 10% to about 50% by weight. In a further embodiment, the amount of starch present in the ingredient(s) utilized for the extruded protein composition may range from about 12% to about 40% by weight. In still another embodiment, the amount of starch present in the ingredient(s) utilized for the extruded protein composition may range from about 15% to about 35% by weight. In a further embodiment, the amount of starch present in the ingredient(s) utilized for the extruded protein composition may range from about 20% to about 30% by weight.

In one embodiment, the ratio of protein to starch present in the extruded protein composition is about 2:1 by weight. In another embodiment, the ratio of protein to starch present in the extruded protein composition is about 1:1 by weight. In an additional embodiment, the ratio of protein to starch present in the extruded protein composition is about 1:2 by weight. In a further embodiment, the ratio of protein to starch present in the extruded protein composition is about 1:3 by weight. In still another embodiment, the ratio of protein to starch present in the extruded protein composition is about 1:4 by weight. In yet another embodiment, the ratio of protein to starch present in the extruded protein composition is about 1:5 by weight.

In one embodiment, the extruded protein composition comprises about 10% protein by weight and about 90% starch by weight. In another embodiment, the extruded protein composition comprises about 20% protein by weight and about 80% starch by weight. In yet another embodiment, the extruded protein composition comprises about 30% protein by weight and about 70% starch by weight. In an additional embodiment, the extruded protein composition comprises about 40% protein by weight and about 60% starch by weight. In a further embodiment, the extruded protein composition comprises about 50% protein by weight and about 50% starch by weight. In another embodiment, the extruded protein composition comprises about 60% protein by weight and about 40% starch by weight. In still another embodiment, the extruded protein composition comprises about 70% protein by weight and about 30% starch by weight. In a further embodiment, the extruded protein composition comprises about 80% protein by weight and about 20% starch by weight. In yet another embodiment, the extruded protein composition comprises about 90% protein by weight and about 10% starch by weight.

Additional Ingredients

In addition to the ingredients detailed in I (a) and I (b) above, a variety of other ingredients may be added to the pre-mix without departing from the scope of the invention. For example, dietary fiber, antioxidants, antimicrobial agents, leavening agents, emulsifiers, and combinations thereof may be included in the pre-mix.

In one embodiment the pre-mix may comprise from about 1% to about 50% dietary fiber. In another embodiment, the pre-mix may comprise from about 5% to about 35% dietary fiber. In still another embodiment, the pre-mix may comprise from about 10% to about 20% dietary fiber.

In another embodiment, the pre-mix may comprise a leavening agent. Non-limiting examples of suitable leavening agents may include sodium bicarbonate, ammonium bicarbonate, potassium bicarbonate, monocalcium phosphate, baking powder, cream of tartar, and mixtures thereof. The percent of the pre-mix comprised of a leavening agent will depend, in part, on the leavening agent used. Generally speaking, a leavening agent may comprise between about 0.1% and 5% of the pre-mix.

In a further embodiment, the pre-mix may comprise an emulsifier. Non-limiting examples of suitable emulsifiers include lecithin, modified lecithin, mono-glycerides, di-glycerides, milk and milk proteins, eggs and egg proteins, and mixtures thereof. The percent of the pre-mix comprised of an emulsifier will depend, in part, on the emulsifier used. Generally, an emulsifier may comprise between about 1% to about 40% of the pre-mix.

Antioxidant additives include BHA, BHT, TBHQ, vitamins A, C and E, and derivatives thereof, and various plant extracts such as those containing carotenoids, tocopherols or flavonoids having antioxidant properties, may be included to increase the shelf-life or nutritionally enhance the extruded protein composition. The antioxidants and the antimicrobial agents may have a combined presence at levels of from about 0.01% to about 10%, preferably, from about 0.05% to about 5%, and more preferably from about 0.1% to about 2%, by weight of the protein-containing materials.

Suitable examples of pre-mix ingredients are detailed in Table B, which shows various combinations.

TABLE B
Pre-Mix Combinations

| Protein source | Starch source | Additional Ingredients |
|---|---|---|
| Plant protein | Tapioca | Dietary fiber |
| Plant protein | Rice | Dietary fiber |
| Plant protein | Corn | Dietary fiber |
| Plant protein | Wheat | Dietary fiber |
| Plant protein | Tapioca | Sodium bicarbonate |
| Plant protein | Rice | Sodium bicarbonate |
| Plant protein | Corn | Sodium bicarbonate |
| Plant protein | Wheat | Sodium bicarbonate |
| Plant protein | Tapioca | Emulsifierl |
| Plant protein | Rice | Emulsifier |
| Plant protein | Corn | Emulsifier |
| Plant protein | Wheat | Emulsifier |
| Plant protein | Tapioca | BHA, BHT, TBHQ |
| Plant protein | Rice | BHA, BHT, TBHQ |
| Plant protein | Corn | BHA, BHT, TBHQ |
| Plant protein | Wheat | BHA, BHT, TBHQ |
| Plant protein | Tapioca | Natural antioxidants |
| Plant protein | Rice | Natural antioxidants |
| Plant protein | Corn | Natural antioxidants |
| Plant protein | Wheat | Natural antioxidants |
| Plant protein | Tapioca | Sodium or potassium lactate |
| Plant protein | Rice | Sodium or potassium lactate |
| Plant protein | Corn | Sodium or potassium lactate |
| Plant protein | Wheat | Sodium or potassium lactate |
| Plant protein | Tapioca | Sodium or potassium diacetate |
| Plant protein | Rice | Sodium or potassium diacetate |
| Plant protein | Corn | Sodium or potassium diacetate |
| Plant protein | Wheat | Sodium or potassium diacetate |
| Plant protein | Tapioca | Dietary fiber and sodium bicarbonate |
| Plant protein | Rice | Dietary fiber and sodium bicarbonate |
| Plant protein | Corn | Dietary fiber and sodium bicarbonate |
| Plant protein | Wheat | Dietary fiber and sodium bicarbonate |
| Plant protein | Tapioca | Dietary fiber and emulsifier |
| Plant protein | Rice | Dietary fiber and emulsifier |
| Plant protein | Corn | Dietary fiber and emulsifier |
| Plant protein | Wheat | Dietary fiber and emulsifier |
| Plant protein | Tapioca | Dietary fiber and BHA, BHT, TBHQ |
| Plant protein | Rice | Dietary fiber and BHA, BHT, TBHQ |
| Plant protein | Corn | Dietary fiber and BHA, BHT, TBHQ |
| Plant protein | Wheat | Dietary fiber and BHA, BHT, TBHQ |
| Plant protein | Tapioca | Dietary fiber and natural antioxidants |
| Plant protein | Rice | Dietary fiber and natural antioxidants |
| Plant protein | Corn | Dietary fiber and natural antioxidants |
| Plant protein | Wheat | Dietary fiber and natural antioxidants |
| Plant protein | Tapioca | Dietary fiber and Sodium or potassium |
| | | lactate |
| Plant protein | Rice | Dietary fiber and Sodium or potassium |
| | | lactate |
| Plant protein | Corn | Dietary fiber and Sodium or potassium |
| | | lactate |
| Plant protein | Wheat | Dietary fiber and Sodium or potassium |
| | | lactate |
| Plant protein | Tapioca | Dietary fiber and Sodium or potassium |
| | | diacetate |
| Plant protein | Rice | Dietary fiber and Sodium or potassium |
| | | diacetate |
| Plant protein | Corn | Dietary fiber and Sodium or potassium |
| | | diacetate |
| Plant protein | Wheat | Dietary fiber and Sodium or potassium |
| | | diacetate |
| Plant protein | Tapioca | Sodium bicarbonate and emulsifier |
| Plant protein | Rice | Sodium bicarbonate and emulsifier |
| Plant protein | Corn | Sodium bicarbonate and emulsifier |
| Plant protein | Wheat | Sodium bicarbonate and emulsifier |
| plant protein | Tapioca | Sodium bicarbonate and BHA, BHT, |
| | | TBHQ |
| Plant protein | Rice | Sodium bicarbonate and BHA, BHT, |
| | | TBHQ |
| Plant protein | Corn | Sodium bicarbonate and BHA, BHT, |
| | | TBHQ |
| Plant protein | Wheat | Sodium bicarbonate and BHA, BHT, |
| | | TBHQ |
| Plant protein | Tapioca | Sodium bicarbonate and natural |
| | | antioxidants |
| Plant protein | Rice | Sodium bicarbonate and natural |
| | | antioxidants |
| Plant protein | Corn | Sodium bicarbonate and natural |
| | | antioxidants |
| Plant protein | Wheat | Sodium bicarbonate and natural |
| | | antioxidants |
| Plant protein | Tapioca | Sodium bicarbonate and sodium or |
| | | potassium lactate |
| Plant protein | Rice | Sodium bicarbonate and sodium or |
| | | potassium lactate |
| Plant protein | Corn | Sodium bicarbonate and sodium or |
| | | potassium lactate |
| Plant protein | Wheat | Sodium bicarbonate and sodium or |
| | | potassium lactate |
| Plant protein | Tapioca | Sodium bicarbonate and sodium or |
| | | potassium diacetate |
| Plant protein | Rice | Sodium bicarbonate and sodium or |
| | | potassium diacetate |
| Plant protein | Corn | Sodium bicarbonate and sodium or |
| | | potassium diacetate |
| Plant protein | Wheat | Sodium bicarbonate and sodium or |
| | | potassium diacetate |
| Plant protein | Tapioca | Emulsifier and BHA, BHT, TBHQ |
| Plant protein | Rice | Emulsifier and BHA, BHT, TBHQ |
| Plant protein | Corn | Emulsifier and BHA, BHT, TBHQ |
| Plant protein | Wheat | Emulsifier and BHA, BHT, TBHQ |
| Plant protein | Tapioca | Emulsifier and natural antioxidants |
| Plant protein | Rice | Emulsifier and natural antioxidants |
| Plant protein | Corn | Emulsifier and natural antioxidants |
| Plant protein | Wheat | Emulsifier and natural antioxidants |
| Plant protein | Tapioca | Emulsifier and sodium or potassium |
| | | lactate |
| Plant protein | Rice | Emulsifier and sodium or potassium |
| | | lactate |
| Plant protein | Corn | Emulsifier and sodium or potassium |
| | | lactate |
| Plant protein | Wheat | Emulsifier and sodium or potassium |
| | | lactate |
| Plant protein | Tapioca | Emulsifier and sodium or potassium |
| | | diacetate |
| Plant protein | Rice | Emulsifier and sodium or potassium |
| | | diacetate |
| Plant protein | Corn | Emulsifier and sodium or potassium |
| | | diacetate |
| Plant protein | Wheat | Emulsifier and sodium or potassium |
| | | diacetate |
| Plant protein | Tapioca | BHA, BHT, TBHQ and sodium or |
| | | potassium lactate |
| Plant protein | Rice | BHA, BHT, TBHQ and sodium or |
| | | potassium lactate |
| Plant protein | Corn | BHA, BHT, TBHQ and sodium or |
| | | potassium lactate |
| Plant protein | Wheat | BHA, BHT, TBHQ and sodium or |
| | | potassium lactate |
| Plant protein | Tapioca | BHA, BHT, TBHQ and sodium or |
| | | potassium diacetate |
| Plant protein | Rice | BHA, BHT, TBHQ and sodium or |
| | | potassium diacetate |
| Plant protein | Corn | BHA, BHT, TBHQ and sodium or |
| | | potassium diacetate |
| Plant protein | Wheat | BHA, BHT, TBHQ and sodium or |
| | | potassium diacetate |
| Plant protein | Tapioca | Natural antioxidants and sodium or |
| | | potassium lactate |
| Plant protein | Rice | Natural antioxidants and sodium or |
| | | potassium lactate |
| Plant protein | Corn | Natural antioxidants and sodium or |
| | | potassium lactate |
| Plant protein | Wheat | Natural antioxidants and sodium or |
| | | potassium lactate |
| Plant protein | Tapioca | Natural antioxidants and sodium or |
| | | potassium diacetate |
| Plant protein | Rice | Natural antioxidants and sodium or |
| | | potassium diacetate |
| Plant protein | Corn | Natural antioxidants and sodium or |
| | | potassium diacetate |
| Plant protein | Wheat | Natural antioxidants and sodium or |
| | | potassium diacetate |

Moisture Content

As will be appreciated by the skilled artisan, the moisture content of the pre-mix can and will vary depending upon the thermal process the pre-mix is subjected to, e.g., retort cooking, microwave cooking, and extrusion. In an exemplary embodiment, the thermal process is extrusion. Generally speaking when the thermal process is extrusion, the moisture content may range from about 1% to about 80% by weight. In low moisture extrusion applications, the moisture content of the pre-mix may range from about 1% to about 35% by weight. Alternatively, in high moisture extrusion applications, the moisture content of the pre-mix may range from about 35% to about 80% by weight depending on the desired expansion, shape, and texture of the finished extrudate product. In an exemplary embodiment, a low moisture extrusion application is utilized to form an extrudate.

Extrusion of the Protein-Containing Materials

A suitable extrusion process for the preparation of an extruded protein composition comprises introducing the protein-containing materials and other ingredients of the pre-mix into a mixing tank (i.e., an ingredient blender) to combine the ingredients and form a dry blended pre-mix. The dry blended pre-mix is then transferred to a hopper from which the dry blended ingredients are introduced along with moisture or steam into a pre-conditioner to form a conditioned mixture. The conditioned mixture is then fed to an extruder in which it is heated under mechanical pressure generated by the screws of the extruder or with the addition of steam into the extruder to form a molten extrusion mass. Water may optionally be introduced to the extruder barrel. The molten extrusion mass exits the extruder through an extrusion die.

Extrusion Process Conditions

Among the suitable extrusion systems useful in the practice of the present invention is a twin-screw extruder as described, for example, in U.S. Pat. No. 4,600,311. Further examples of suitable commercially available extrusion systems may be built around a CLEXTRAL Model BC-72 extruder manufactured by Clextral, Inc. (Tampa, Fla.); a WENGER Model TX-57 extruder, a WENGER Model TX-168 extruder, and a WENGER Model TX-52 extruder all manufactured by Wenger Manufacturing, Inc. (Sabetha, Kans.). Other conventional extrusion systems suitable for use in this invention are described, for example, in U.S. Pat. Nos. 4,763,569, 4,118,164, and 3,117,006, which are hereby incorporated by reference in their entirety.

The screws of a twin-screw extruder can rotate within the barrel in the same or opposite directions. Rotation of the screws in the same direction is referred to as single flow or co-rotating whereas rotation of the screws in opposite directions is referred to as double flow or counter-rotating. The speed of the screw or screws of the extruder may vary depending on the particular system; however, it is typically from about 200 to about 1200 revolutions per minute (rpm). Generally, as the screw speed increases, the density of the extrudate will decrease. The extrusion system contains screws assembled from shafts and worm segments, as well as mixing lobes and ring-type shearing elements as recommended by the extrusion system manufacturer for extruding protein-containing material or by one skilled in the art. The extrusion system may contain a vented barrel set up as disclosed in U.S. Pat. No. 4,763,569 and previously incorporated by reference. The extrusion system may contain a vented barrel set up with a vacuum system, or similarly except without a vacuum system and a stuffing auger, or similarly except without a vent.

Alternatively, the extrusion system utilized in the practice of the present invention may be built around a single-screw extruder. Examples of suitable, commercially available single-screw extrusion systems include the Wenger X-175, the Wenger X-165, and the Wenger X-85, all of which are available from Wenger Manufacturing, Inc. In one embodiment, the single-screw extruder is a high shear cooking extruder. In another embodiment, the single-screw extruder is a low shear forming extruder. In yet another embodiment, a combination of a high shear cooking extruder and a low shear forming extruder may be used. In a further embodiment, a combination twin-screw extruder with a forming single-screw extruder may be used.

The extruder generally comprises a plurality of temperature control zones through which the conditioned mixture is conveyed under mechanical pressure prior to exiting the extruder through an extrusion die. In one embodiment, the conditioned mixture is transferred through four temperature control zones within the extruder, with the conditioned mixture reaching a temperature of from about 40° C. to about 90° C. such that it enters the extrusion die at a temperature of less than about 100° C. In another embodiment, the conditioned mixture is fully cooked then cooled prior to exiting the extruder through an extrusion die. In another embodiment, the conditioned mixture is passed through the length of a screw extruder through a cooking zone, then through a venting zone and a forming zone to an extrusion die to yield an extruded product. In this embodiment, the conditioned mixture may have a temperature of up to about 115° C. in the cooking zone.

The pressure within the extruder barrel is typically between about 40 psig to about 1500 psig. Generally, the pressure within the extruder is from about 50 psig to about 500 psig. The barrel pressure is dependent on numerous factors including, for example, the extruder screw speed, feed rate of the mixture to the barrel, feed rate of water to the barrel, screw configuration, die opening, the viscosity of the molten mass within the barrel, and the use of a vent system.

Water may be injected into the extruder barrel to hydrate, flavor, color, or modify the resulting texture of the conditioned mixture. Water includes liquids and mixtures of liquids. As an aid in forming the molten extrusion mass, the water may act as a plasticizing agent. Water may be introduced to the extruder barrel via one or more injection jets. Typically, the conditioned mixture in the barrel contains from about 10% to about 50% by weight water depending on the extruder. The rate of introduction of water is generally controlled to promote production of an extrudate having desired characteristics. It has been observed that as the rate of introduction of water to the barrel decreases, the density of the extrudate decreases. Typically, less than about 1 kg of water per kg of conditioned mixture is introduced to the barrel. Preferably, from about 0.1 kg to about 1 kg of water per kg of conditioned mixture is introduced to the barrel.

Preconditioning

In a pre-conditioner, the pre-mix may be preheated by direct injection of steam or indirectly by heating the pre-conditioner's enclosure. The pre-mix may then be contacted with moisture and held under controlled temperature and pressure conditions allowing the moisture to penetrate and soften the individual particles. The preconditioner contains one or more paddles to promote uniform mixing of the pre-mix and transfer of the pre-mix through the preconditioner. The configuration, rotational speed, and direction of the paddles vary widely, depending on the capacity of the preconditioner, the extruder throughput and/or the desired residence time of the pre-mix in the preconditioner or extruder barrel. Generally, the speed of the paddles is from about 100 to about 1300 revolutions per minute (rpm). Agitation must be high enough to obtain even hydration and good mixing.

Generally, the pre-mix is conditioned prior to introduction into the extrusion apparatus by contacting the pre-mix with moisture (i.e., steam and/or water). Preferably the pre-mix is heated to a temperature from about 20° C. to about 80° C., more preferably from about 30° C. to about 60° C. in the preconditioner.

The pre-mix is typically conditioned for a period of about 30 seconds to about 60 seconds, depending on the speed, size, and type of conditioner. Types of conditioners include vertical, horizontal, and combinations thereof. The pre-mix is contacted with steam and/or water and heated in the pre-conditioner at generally constant steam flow to achieve the desired temperatures. The water and/or steam conditions (i.e., hydrates) the pre-mix, increases its density, and facilitates the flowability of the dry blended pre-mix without interference prior to introduction to the extruder barrel. If a low moisture pre-mix is desired, the conditioned mixture may contain from about 1% to about 35% (by weight) water. If a high moisture premix is desired, the conditioned mixture may contain from about 35% to about 80% (by weight) water.

The conditioned mixture typically has a bulk density of from about 0.2 g/cm³ to about 0.4 g/cm³. As the bulk density of the conditioned mixture increases within this range, the conditioned mixture becomes easier to process.

Extrusion Process

The conditioned mixture is then fed into an extruder to heat, shear, and ultimately plasticize the mixture. The extruder may be selected from any commercially available extruder and may be a single-screw extruder or preferably a twin-screw extruder.

The feed rate depends on the capabilities of the extruder. Capabilities include diameter, speed, and configuration of the extruder. In one embodiment using a particular extruder, the conditioned mixture is generally introduced to the extrusion apparatus at a rate of no more than about 25 kilograms per minute.

The conditioned mixture is subjected to shear and pressure by the extruder to plasticize the mixture forming a molten extrusion mass. The screw elements of the extruder shear the conditioned mixture as well as create pressure in the extruder by forcing the mixture forwards though the extruder and through the die. The screw motor speed can be used to vary the amount of shear and pressure applied to the mixture by the screw(s). Preferably, the screw motor speed is set to a speed of from about 200 rpm to about 1500 rpm, and more preferably from about 250 rpm to about 350 rpm, which moves the molten extrusion mass through the extruder. Preferably the extruder generates an extruder barrel exit pressure of from about 100 psig to about 1500 psig, and more preferably an extruder barrel exit pressure of from about 100 psig to about 1000 psig is generated.

The extruder controls the temperature of the conditioned mixture as it passes through the extruder denaturing the protein in the mixture. The extruder includes a means for controlling the temperature of the conditioned mixture to ensure temperatures of from about 40° C. to about 120° C. Typically, the means for controlling the temperature of the conditioned mixture in the extruder comprises extruder barrel jackets into which heating or cooling media such as steam or water may be introduced to control the temperature of the conditioned mixture passing through the extruder. The barrel jackets may also be heated using electrical resistance, microwave heaters, or induction heaters. The extruder may also include steam injection ports for directly injecting steam into the conditioned mixture within the extruder. The extruder preferably includes multiple temperature control zones that can be controlled to independent temperatures, where the temperatures of the temperature control zones are preferably set to increase the temperature of the conditioned mixture as it proceeds through the extruder. For example, the extruder may be set in a four temperature control zone arrangement, where the first zone (adjacent the extruder inlet port) is set to a temperature of from about 30° C. to about 60° C., the second zone is set to a temperature of from about 40° C. to 70° C., the third zone is set to a temperature of from 50° C. to about 80° C., and the fourth zone (adjacent the extruder exit port) is set to a temperature of from 50° C. to 70° C. The extruder may be set in other temperature zone arrangements, as desired. For example, the extruder may be set in a five temperature zone arrangement, where the first zone is set to a temperature of about 35° C., the second zone is set to a temperature of about 50° C., the third zone is set to a temperature of about 65° C., the fourth zone is set to a temperature of about 60° C., and the fifth zone is set to a temperature of about 60° C.

The conditioned mixture forms a molten extrusion mass in the extruder. A die assembly is attached to the extruder in an arrangement that permits the molten extrusion mass to flow from an extruder exit port into the die assembly. The molten extrusion mass exits the die through at least one aperture in the periphery or side of the die assembly. The die determines the final product shape. Final product shapes include, for example, stars, grain kernels, wheels, balls, tubes, animals, fruits, swiggles, and wafers.

Alternatively, a cooling die may be attached to the extruder. The cooling die cools and shapes the molten extrusion mass as it exits the extruder. The material exits the cooling die through at least one aperture in the die face, which may be a die plate affixed to the die. The cooling die is maintained at a temperature significantly cooler than the temperature in the extruder in the final temperature zone of the extruder adjacent the die. The cooling die includes means for maintaining the temperature at a temperature significantly cooler than the exit temperature of the extruder. Preferably the cooling die includes inlet and outlet ports for circulating media for maintaining the die temperature. Most preferably, constant temperature water is circulated through the cooling die as the circulating media for maintaining the desired die temperature. In one embodiment, the cooling die is maintained at a temperature of from about 40° C. to about 90° C. In another embodiment, the cooling die is maintained at a temperature of from about 50° C. to about 80° C. In yet another embodiment, the cooling die is maintained at a temperature of from about 60° C. to about 70° C. Another embodiment uses a cooling section in the extruder that is maintained at a temperature of between about 20° C. to about 40° C.

Drying

The extrudate produced in I (e) is typically dried to reduce its moisture content to a desired level. The dryer generally comprises a plurality of drying zones in which the humidity, airflow and temperature are carefully controlled. The extrudate will be present in the dryer for a time sufficient to provide an extrudate having the desired moisture content. Thus, the temperature of the air is not important, if a lower temperature is used longer drying times will be required than if a higher temperature is used. Generally, the temperature of the air within one or more of the zones will be from about 60° C. to about 185° C. The relative humidity within the dryer is generally from about 40% to about 90%. Typically, the extrudate is present in the dryer for a time sufficient to provide an extrudate having a desired moisture content. The extrudate may be further dried and cooled at room temperature. Generally, the total drying time ranges from about 1 hour to about 24 hours. Suitable dryers include those manufactured by CPM Wolverine Proctor LLC (Horsham, Pa.), National Drying Machinery Co. (Philadelphia, Pa.), Wenger Manufacturing, Inc. (Sabetha, Kans.), Aeroglide Corp. (Raleigh, N.C.), and Buhler, Inc. (Plymouth, Minn.). Once dried, the extrudate typically has a moisture content of about 4% to about 15%. In one embodiment, the dried extrudate has a moisture content of about 9% to about 12%.

Characterization of the Extruded Protein Composition

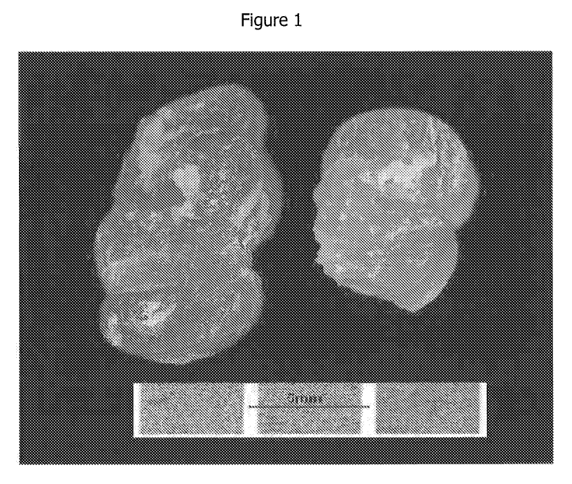

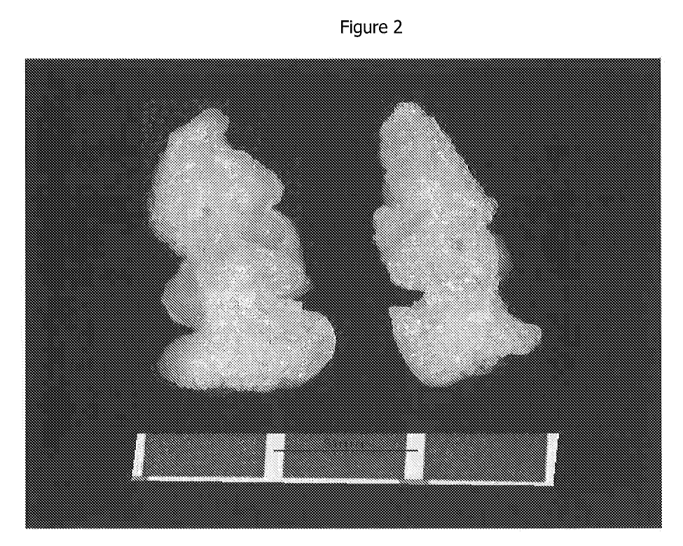

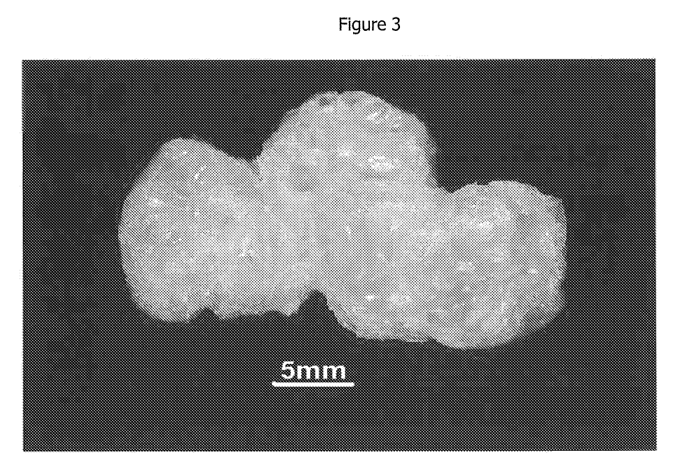

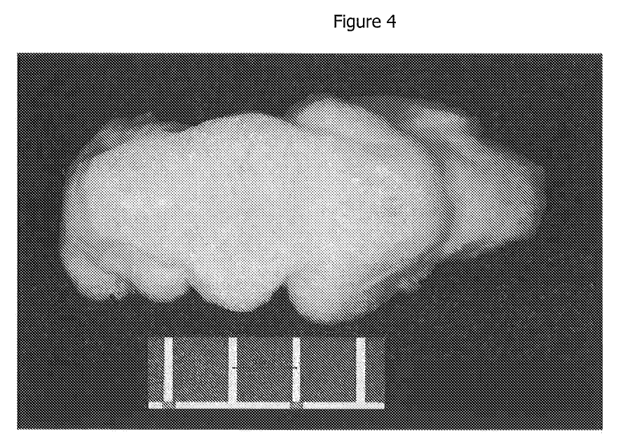

The extruded protein composition produced in I (e) typically comprises protein matrices that have a substantially closed cell structure. Methods for determining the cell structure of protein matrices are known in the art and include visual determinations based upon micrographic images. By way of example, FIGS. 1 and 2 depict micrographic images that illustrate an extruded protein composition having protein matrices that have a substantially closed cell structure. FIG. 1 depicts an extruded protein composition having no added fiber and prepared according to I (a)-I (e) comprising protein matrices that have a substantially closed cell structure. FIG. 2 depicts an extruded protein composition having added fiber and prepared according to I (a)-I (e) comprising protein matrices that have a substantially closed cell structure. Because the protein matrices have a substantially closed cell structure, as shown in FIG. 1, the extruded protein compositions utilized in the invention generally comprise a density of between about 0.3 g/cm³ to about 1.5 g/cm³. In one embodiment, the extruded protein composition has a density in the range of about 0.4 g/cm³ to about 1.5 g/cm³. In another embodiment, the extruded protein composition has a density in the range of about 0.5 g/cm³ to about 1.5 g/cm³. In contrast, FIGS. 3 and 4 depict micrographic images that illustrate the puffed or expanded extruded protein composition having protein matrices that have a substantially open cell structure. FIG. 3 depicts a puffed or expanded extruded protein composition having no added fiber and prepared according to I (a)-I (e) comprising protein matrices that have a substantially open cell structure. FIG. 4 depicts a puffed or expanded extruded protein composition having added fiber and prepared according to I (a)-I (e) comprising protein matrices that have a substantially open cell structure. The puffed or expanded extruded protein compositions comprising protein matrices having a substantially open cell structure, as shown in FIGS. 3 and 4, generally have a density of less than about 0.3 g/cm³.

Uses for Extruded Protein Compositions

Extruded Protein Compositions

It is envisioned that the extruded protein composition of the invention will typically be puffed before being consumed. The extruded protein composition may be puffed or expanded by any known heating method, for example, frying, baking (hot air impingement), or microwave heating. In an exemplary embodiment, the extruded protein composition is puffed or expanded by heating in a microwave oven. The extruded protein composition may be puffed by the end-user or by a manufacturer. The extruded protein composition may be heated to a temperature of about 100° C. for between about 1 second to about 300 seconds, or more preferably between about 60 seconds to about 901 seconds, in order to yield a puffed or expanded protein composition that has a substantially open cell structure.

The extruded protein composition of the invention may be eaten alone, or in combination with another food ingredient, as described below. It is envisioned that the extruded protein composition may be eaten similarly to other snack foods. Additionally, the extruded protein composition may be used as a cracker or a wafer. It is envisioned that the cracker or wafer-like extruded protein composition may be used with dips or spreads, similar to conventional crackers or wafers. Moreover, it is envisioned that the cracker or wafer-like extruded protein composition may be flavored or colored similar to conventional crackers or wafers. Suitable flavors or colors are described in more detail below.

The extruded protein composition may optionally include a variety of flavorings, spices, antioxidants, or other ingredients to nutritionally enhance the final food product. As will be appreciated by a skilled artisan, the selection of ingredients added to the extruded protein composition can and will depend upon the final food product desired. One skilled in the art will be capable of determining the best method of applying the additional ingredients whether topically, such as by enrobing or by spraying, or internally, such as by injection or infusing.

In one embodiment, the extruded protein composition may further comprise a flavoring agent. The flavoring agent may include any suitable edible flavoring agent known in the art including, but not limited to, salt, any flower flavor, any spice flavor, vanilla, any fruit flavor, caramel, nut flavors, beef, poultry (e.g. chicken or turkey), pork or seafood flavors, dairy flavors such as butter and cheese, any vegetable flavor and combinations thereof.

For instance, the extruded protein composition may be flavored with salt and/or a dairy flavor. Salt may include sodium, potassium, or calcium salts. For a salt/butter mixture, the butter flavoring may be provided through the utilization of artificial butter flavors. In general, a cheese flavor can be accomplished through utilization of, in addition to salt and butter flavor, commercial cheese flavors (e.g. Tastemaker Cheese flavors #308342, #308962 or #304558; Tastemaker, Cincinnati, Ohio).

The flavoring may also be sweet. Sugar, whey, corn syrup solids, and fructose may be used for sweet flavors. Also, a sweetened flavor may include the following artificial flavors. Sunette, acesulfone potassium, available from Hoechst Celanese (Edison, N.J.); Aspartame 200 available from Sanofi Bio-Industries (Fairfield, N.J.). Additionally, other sweet flavors may be used (e.g. chocolate, chocolate mint, caramel, toffee, butterscotch, mint, chocolate banana, vanilla, and peppermint flavorings). Sugar alcohols may also be used as sweeteners.

A wide variety of fruit or citrus flavors may also be used. Non-limiting examples of fruit or citrus flavors include strawberry, pineapple, coconut, cherry, orange, and lemon flavors.

A wide variety of spice flavors may also be used. Non-limiting examples include herb and garlic, sour cream and onion, honey mustard, hot mustard, dry roast, barbecue, jalapeno, red peppers, garlic, chili, sweet and sour seasoning, sweet seasoning, hot and spicy seasoning, savory flavor seasoning, and vegetable seasonings, or any combination thereof.

Other flavorings may include monosodium glutamate, vinegar, hydrolyzed vegetable proteins, yeast autolysates, peanut flavors, yeast extracts, flavor reaction products, flavor solvents (such as propylene glycol, triacetin, benzyl alcohol, glycerin, ethyl and propyl alcohol), natural flavors, artificial flavors, genetically modified organism—free flavors, and organic flavors.

In an additional embodiment, the extruded protein composition may further comprise a coloring agent. The coloring agent may be any suitable food coloring, additive, dye or lake known to those skilled in the art. For instance, it may be desirable to use a yellow dye, to provide a desirable yellow hue similar to buttered popcorn. Yellow #5, Aluminum lake or Tumeric are some of the possible colorants for this purpose.

Additional food colorants may include, but are not limited to, for example, Food, Drug and Cosmetic (FD&C) Blue No. 1, FD&C Blue No. 2, FD&C Green No. 3, FD&C Red No. 3, FD&C Red No. 40, FD&C Yellow No. 5, FD&C Yellow No. 6, Orange B, Citrus Red No. 2 and combinations thereof. Other coloring agents may include annatto extract, b-apo-8′-carotenal, beta-carotene, beet powder, canthaxanthin, caramel color, carrot oil, cochineal extract, cottonseed flour, ferrous gluconate, fruit juice, grape color extract, paprika, riboflavin, saffron, titanium dioxide, turmeric, and vegetable juice. These coloring agents may be combined or mixed as is common to those skilled in the art to produce a final coloring agent.

In certain embodiments, both a coloring agent and a flavoring agent may be used. For example, a strawberry flavoring agent may be combined with FD&C Red No. 3 to enhance the aesthetic appeal of the extruded protein composition. Similarly, an edible aromatic agent as known in the art may be added to the extruded protein composition.

In a further embodiment, the extruded protein composition may further comprise a nutrient such as a vitamin, a mineral, an antioxidant, an omega-3 fatty acid, or an herb. Suitable vitamins include Vitamins A, C, and E, which are also antioxidants, and Vitamins B and D. Examples of minerals that may be added include the salts of aluminum, ammonium, calcium, magnesium, and potassium. Suitable omega-3 fatty acids include docosahexaenoic acid (DHA). Herbs that may be added include basil, celery leaves, chervil, chives, cilantro, parsley, oregano, tarragon, and thyme.

In yet another embodiment, the extruded protein composition may further comprise a leavening agent, such as sodium bicarbonate, ammonium bicarbonate, potassium bicarbonate, monocalcium phosphate, baking powder, and cream of tartar.

In another embodiment, the extruded protein composition may further comprise an emulsifier, such as lecithin, modified lecithin, mono-glycerides, di-glycerides, milk and milk proteins, eggs and egg proteins, and mixtures thereof.

Food Products Comprising Extruded Protein Compositions

Another aspect of the invention provides a food product. Generally the food product comprises the extruded protein composition combined with an additional food ingredient. In some embodiments, the extruded protein composition is first puffed or expanded with heat prior to being combined with an additional food ingredient.

In one embodiment, the food ingredient that the puffed or expanded extruded protein composition is combined with may be one or more snack foods. For instance, the extruded protein composition may be combined with popcorn, nuts (including peanuts, hazelnuts, walnuts, almonds, and macadamia nuts), candy (including chocolate), granola, pretzels, trail mix, dehydrated fruit pieces, dehydrated vegetable pieces, crackers (including flavored crackers), potato chips, tortilla chips, pork rinds, and other snack foods, or any combination thereof.

Popcorn

In one embodiment, the extruded protein composition is combined with popcorn. The mixture may comprise about 1 to about 10% of extruded protein composition, or alternatively about 10 to about 30%, about 30 to about 50%, about 50 to about 70%, or about 70 to about 100% of extruded protein composition. The extruded protein composition may be puffed first, and then added to the popped popcorn, or alternatively, the extruded protein composition and the popcorn kernels may be heated together. If the extruded protein composition is heated together with the popcorn, the combination of the extruded protein composition and the unpopped popcorn may have a different popping time and may result in a higher yield of unpopped popcorn kernels.

In another embodiment, the extruded protein composition is first puffed and then either alone or in combination with popped popcorn mixed with syrup or other binders and pressed or formed into cakes. The extruded protein composition can be combined with popcorn kernels into a heated mold with syrup or other binders and popped to the mold's shape.

Both the extruded protein composition and the popcorn may be flavored or colored by methods known in the art. Non-limiting examples of suitable flavors or colors are listed in section (II)(a) above. In an exemplary embodiment, the extruded protein composition may be flavored with salt and/or a dairy flavor. Salt may include sodium, potassium, or calcium salts. Dairy flavors may include butter or cheese. For a salt/butter mixture, the butter flavoring may be provided through the utilization of artificial butter flavors known in the art. In general, a cheese flavor can be accomplished through utilization of, in addition to salt and a butter flavor, commercial cheese flavors (e.g. Tastemaker Cheese flavors #308342, #308962 or #304558; Tastemaker, Cincinnati, Ohio). For a mixture of popcorn and extruded protein composition, it may be desirable to use a yellow dye, to provide a desirable yellow hue similar to buttered popcorn. Yellow #5, Aluminum lake or Tumeric are some of the possible colorants for this purpose.

In another exemplary embodiment, the flavoring of the mixture of popcorn and extruded protein composition flavoring may be sweet. Sugar, whey, corn syrup solids, and fructose may be used for sweet flavors. Additionally, other sweet flavors may be used (e.g. chocolate, chocolate mint, caramel, toffee, butterscotch, mint, chocolate banana, vanilla, peppermint, and fruit flavorings). Sugar alcohols may also be used as sweeteners. In certain embodiments, both a coloring agent and a sweet flavoring agent may be used. For example, a strawberry flavoring agent may be combined with FD&C Red No. 40 to enhance the aesthetic appeal of the popcorn and extruded protein composition mixture. Similarly, an edible aromatic agent as known in the art may be added to the mixture.

Cereal

In other embodiments, the extruded protein composition may be combined with a cereal. The cereal may be either a cold cereal (e.g. breakfast cereals) or a warm cereal (e.g. oatmeal). The extruded protein composition may be puffed first, and then added to the cereal, or the combination of the cereal and the extruded protein composition may be heated together. The mixture may comprise about 1 to about 10% of extruded protein composition, or alternatively about 10 to about 30%, about 30 to about 50%, about 50 to about 70%, or about 70 to about 100% of extruded protein composition.

It is envisioned that the extruded protein composition may be flavored or colored similar to traditional cereals. Non-limiting examples of suitable flavors or colors are listed in section (II)(a) above. For instance, the extruded protein composition and cereal mixture may have a sweet flavor. Sugar, whey, corn syrup solids, and fructose may be used for sweet flavors. Additionally, other sweet flavors may be used (e.g. chocolate, chocolate mint, caramel, toffee, butterscotch, mint, chocolate banana, vanilla, peppermint, and fruit flavorings, including strawberry, pineapple, coconut, cherry, orange, and lemon flavors). Sugar alcohols may also be used as sweeteners.

Other Combinations

In still other embodiments, the extruded protein composition may be included in a snack bar, such as a granola bar. Typically, the extruded protein composition would be puffed or expanded by heating, and then added to a mixture of ingredients that comprised the snack bar. In some embodiments, the extruded protein composition would be added to snack bars that are high in protein, low in carbohydrates, or low in fat.

### DEFINITIONS

The term “extrudate” as used herein refers to the product of extrusion. In this context, the protein-containing material comprising protein matrices that have a substantially closed cell structure may be extrudates in some embodiments.

The term “extrusion system” as used herein refers to the sum of parts that mix or blend ingredients, transfer the ingredients, meter the ingredients, precondition the ingredients, inject liquids, gasses or solids into the ingredients, along with the extruder and its screw (worm) parts, dies, cutting mechanism, and drying equipment.

The term “fiber bundles” as used herein refers to tightly bound protein molecules having a texture similar to “textured vegetable protein.” This texture is typically dense, chewy, and tough.

The term “gluten” as used herein refers to a protein fraction in cereal grain flour, such as wheat, that possesses a high content of protein as well as unique structural and adhesive properties.

The term “gluten free starch” as used herein refers to modified tapioca starch. Gluten free or substantially gluten free starches are made from wheat, corn, and tapioca based starches. They are gluten free because they do not contain the gluten from wheat, oats, rye or barley.

The term “protein matrix” or “protein matrices” as used herein refers to the molecular network of proteins, carbohydrates, fats, minerals, and other materials that together define the structure of the extruded protein composition of the invention. The other materials may be added by formulation, entrained from the surrounding environment, or results of secondary reactions resulting from the process or chemistries involved.

The term “soy cotyledon fiber” as used herein refers to the polysaccharide portion of soy cotyledons containing at least about 70% dietary fiber. Soy cotyledon fiber typically contains some minor amounts of soy protein, but may also be 100% fiber. Soy cotyledon fiber, as used herein, does not refer to, or include, soy hull fiber. Generally, soy cotyledon fiber is formed from soybeans by removing the hull and germ of the soybean, flaking or grinding the cotyledon and removing oil from the flaked or ground cotyledon, and separating the soy cotyledon fiber from the soy material and carbohydrates of the cotyledon.

The term “soy protein concentrate” as used herein is a soy material having a protein content of from about 65% to less than about 90% soy protein on a moisture-free basis. Soy protein concentrate also contains soy cotyledon fiber, typically from about 3.5% up to about 20% soy cotyledon fiber by weight on a moisture-free basis. A soy protein concentrate is formed from soybeans by removing the hull and germ of the soybean, flaking or grinding the cotyledon and removing oil from the flaked or ground cotyledon, and separating the soy protein and soy cotyledon fiber from the soluble carbohydrates of the cotyledon.

The term “soy flour” as used herein, refers to a comminuted form of defatted soybean material, preferably containing less than about 1% oil, formed of particles having a size such that the particles can pass through a No. 100 mesh (U.S. Standard) screen. The soy cake, chips, flakes, meal, or mixture of the materials are comminuted into a soy flour using conventional soy grinding processes. Soy flour has a soy protein content of about 49% to about 65% on a moisture free basis. Preferably the flour is very finely ground, most preferably so that less than about 1% of the flour is retained on a 300 mesh (U.S. Standard) screen.

The term “soy protein isolate” as used herein is a soy material having a protein content of at least about 90% soy protein on a moisture free basis. A soy protein isolate is formed from soybeans by removing the hull and germ of the soybean from the cotyledon, flaking or grinding the cotyledon and removing oil from the flaked or ground cotyledon, separating the soy protein and carbohydrates of the cotyledon from the cotyledon fiber, and subsequently separating the soy protein from the carbohydrates.

The term “substantially closed cell structure” as used herein refers to a structure comprised of gas cells (i.e. voids), where substantially each cell is independent and not connected to a neighboring cell. This is in contrast to an open cell structure, wherein substantially every cell is connected to a neighboring cell. “Substantially,” in this use, refers to the fact that greater than about 70% of the cells are closed. As used in herein, a substantially closed cell structure typically has a density between about 0.3 g/cm³ and about 1.5 g/cm³. In one embodiment, a substantially closed cell structure may have a density between about 0.3 g/cm³ and about 1.0 g/cm³.

The term “starch” as used herein refers to starches derived from any native source. Typically sources for starch are cereals, tubers, roots, legumes, vegetables, and fruits.

The term “wheat flour” as used herein refers to flour obtained from the milling of wheat. Generally speaking, the particle size of wheat flour is from about 14 to about 120 μm.

### EXAMPLES

Examples 1-2 illustrate various embodiments of the invention.

### Example 1

Table 1 below summarizes fourteen possible formulations for the extruded protein compositions of the invention. The formulations for samples 1-11 were made in 150 lb batches, whereas the formulations for samples 12-14 were made in 120 lb batches. Both formulation weights were extruded using a Wenger TX52 extruder under conditions described above.

Samples 1-3 were comprised of 68.75% tapioca starch, 30% of Supro® 8000, 0.5% Solex F, and 0.75% baking soda. Sample 1 was dried in a tray dryer at 160° F. for 18 min to 22.69% moisture. Sample 2 was dried in the same manner to 21.76% moisture. Sample 3 was dried in a Proctor and Schwartz drier at 250° F. for 16 min to 18.84% moisture. Final moisture readings were taken again after the extrudate was dried at ambient temperature for 8 hrs. Samples 1-3 had final moisture readings of 10.55%, 11%, and 11.95% moisture respectively.

Sample 4 was comprised of 78.75% tapioca starch, 20% Supro® 8000, 0.5% Solex F, and 0.75% baking soda. Sample 5 was comprised of 79.5% tapioca starch, 20% Supro® 8000, and 0.5% Solex F. Sample 6 was comprised of 48.75% tapioca starch, 50% Supro® 8000, 0.5% Solex F, and 0.75% baking soda. Sample 7 was comprised of 18.75% tapioca starch, 80% Supro® 8000, 0.5% Solex F, and 0.75% baking soda. Samples 4-7 were dried in a tray dryer at 160° F. for 18 min to a moisture content of 21.73% for sample 4, 21.94% for sample 5, 22.05% for sample 6, and 22.16% for sample 7.

Sample 8 was comprised of 79.5% tapioca, 20% wheat gluten, and 0.5% Solex F. Sample 9 was comprised of 79.5% tapioca starch, 20% whey protein concentrate (WPC 80), and 0.5% Solex F. Sample 10 was comprised of 29.5% Supro® 8000, 5% beef jerky rework, 33% yellow corn flour, 30% rice flour, 2% sugar, and 0.5% salt. Samples 8-10 were dried in a try dryer at 160° F. Sample 8 was dried for 20 min to 22.69% moisture, sample 9 for 17.5 min to 21.87% moisture, and sample 10 for 30 min to 22.45% moisture.

Sample 11 was comprised of 79.5% Tapioca Starch, 20% SUPRO® 8000, and 0.5% Solex F. Samples 12-14 each were comprised of 79.5% Tapioca Starch, 10% SUPRO® 8000, and 0.5% Solex F. Additionally, sample 12 was comprised of 10% whey protein concentrate (WPC 80), sample 13 was comprised of 10% whey protein isolate (Bipro), and sample 14 was comprised of 10% sodium casinate. Samples 11-14 were dried in a tray dryer for 18 minutes.

TABLE 1
Summary of extruded protein formulations and conditions

| | | | Extruder die | |
|---|---|---|---|---|
| Sample | | Extrusion | (mm), round | |
| ID | Protein Source | Moisture % | die insert | Drying condition |
| Sample | 30% SUPRO ® 8000, with | 33.7 | 3.0 | Tray dryer, 160° F./18 |
| #1 | NaHCO₃ | | | min |
| Sample | 30% SUPRO ® 8000, with | 35.3 | 3.0 | Tray dryer, 160° F./18 |
| #2 | NaHCO₃ | | | min |
| Sample | 30% SUPRO ® 8000, with | 35.3 | 3.0 | Continuous dryer |
| #3 | NaHCO₃ | | | 250° F./10 min |
| Sample | 20% SUPRO ® 8000, with | 37.9 | 3.0 | Tray dryer, 160° F./18 |
| #4 | NaHCO₃ | | | min |
| Sample | 20% SUPRO ® 8000, no | 37.9 | 3.0 | Tray dryer, 160° F./18 |
| #5 | NaHCO₃ | | | min |
| Sample | 50% SUPRO ® 8000, with | 37.9 | 3.0 | Tray dryer, 160° F./18 |
| #6 | NaHCO₃ | | | min |
| Sample | 80% SUPRO ® 8000, with | 38.2 | 3.0 | Tray dryer, 160° F./18 |
| #7 | NaHCO₃ | | | min |
| Sample | 20% vital wheat gluten, no | 36.0 | 5.0 | Tray dryer, 160° F./20 |
| #8 | NaHCO₃ | | | min |
| Sample | 20% whey protein | 32.9 | 5.0 | Tray dryer, |
| #9 | concentrate 80, no | | | 160° F./17.5 min |
| | NaHCO₃ | | | |
| Sample | 30% SUPRO ® 8000, 5% | 34.9 | 5.0 | Tray dryer, 160° F./30 |
| #10 | beef jerky, no NaHCO₃ | | | min |
| Sample | 20% SUPRO ® 8000, no | 42.6 | 3.0 | Tray dryer, 160° F./18 |
| #11 | NaHCO₃ | | | min |
| Sample | 10% SUPRO ® 8000, 10% | 41.3 | 3.0 | Tray dryer, 160° F./18 |
| #12 | Whey Protein | | | min |
| | Concentrate, no NaHCO₃ | | | |
| Sample | 10% SUPRO ® 8000, 10% | 39.2 | 3.0 | Tray dryer, 160° F./18 |
| #13 | Whey Protein Isolate, no | | | min |
| | NaHCO₃ | | | |
| Sample | 10% SUPRO ® 8000, 10% | 43.2 | 3.0 | Tray dryer, 160° F./18 |
| #14 | Sodium Casinate, no | | | min |
| | NaHCO₃ | | | |

Within Table 1, “extrusion moisture %” is equal to the sum of the total water added plus the water in the dry mix divided by the sum of the total water added plus the dry mix, wherein the quotient is multiplied by 100, wherein total water added is equal to the water added from the pre-conditioner plus the water added from the barrel.

For each sample described in Table 1, Table 2 provides certain physical characteristics of the extrudate. Within Table 2, the term “expansion ratio” is equal to the diameter of the extrudate divided by the diameter of the die.

TABLE 2
Physical property of the extrudate

| | | Bulk | Moisture | |
|---|---|---|---|---|
| Sample | | density | (%) | Expansion |
| ID | Protein Source | (g/cm³) | ER | ratio* |
| Sample | 30% SUPRO ® 8000, with | 0.51 | 10.72 | 2.75 |
| #1 | NaHCO₃ | | | |
| Sample | 30% SUPRO ® 8000, with | 0.57 | 10.71 | 2.33 |
| #2 | NaHCO₃ | | | |
| Sample | 30% SUPRO ® 8000, with | 0.42 | 10.88 | 2.88 |
| #3 | NaHCO₃ | | | |
| Sample | 20% SUPRO ® 8000, with | 0.59 | 10.34 | 2.05 |
| #4 | NaHCO₃ | | | |
| Sample | 20% SUPRO ® 8000, no | 0.64 | 10.21 | 2.41 |
| #5 | NaHCO₃ | | | |
| Sample | 50% SUPRO ® 8000, with | 0.58 | 8.69 | 2.08 |
| #6 | NaHCO₃ | | | |
| Sample | 80% SUPRO ® 8000, with | 0.57 | 11.73 | 1.50 |
| #7 | NaHCO₃ | | | |
| Sample | 20% Vital Wheat Gluten, no | 0.60 | N/A | 2.65 |
| #8 | NaHCO₃ | | | |
| Sample | 20% Whey Protein | 0.59 | N/A | 2.13 |
| #9 | Concentrate 80, no NaHCO₃ | | | |
| Sample | 30% SUPRO ® 8000, | 0.65 | N/A | 1.70 |
| #10 | 5% beef jerky, no NaHCO₃ | | | |
| Sample | 20% SUPRO ® 8000, | 0.64 | 12.63 | 2.46 |
| #11 | no NaHCO₃ | | | |
| Sample | 10% SUPRO ® 8000, 10% | 0.63 | 10.96 | 2.46 |
| #12 | Whey Protein Concentrate | | | |
| | (WPC 80), no NaHCO₃ | | | |
| Sample | 10% SUPRO ® 8000, 10% | 0.62 | 11.81 | 2.58 |
| #13 | Whey Protein Isolate, | | | |
| | no NaHCO₃ | | | |
| Sample | 10% SUPRO ® 8000, | 0.54 | 11.24 | 2.67 |
| #14 | 10% Sodium Caseinate, no | | | |
| | NaHCO₃ | | | |

### Example 2

### Production of Extruded Protein Compositions

The following extrusion process may be used to prepare the extruded protein compositions of the invention. Added to a dry blend mixing tank are the following: 450 kilograms (kg) Supro® 8000 (soy isolate), 1,030 kg tapioca starch, 7.5 kg Solex F, and 12.5 kg baking soda. The contents are mixed to form a dry blended pre-mix. The dry blended pre-mix is then transferred to a hopper from which the dry blended pre-mix is introduced into a preconditioner along with 480 kg of water to form a conditioned mixture. The conditioned mixture is then fed to a twin-screw extrusion apparatus at a rate of not more than 25 kg/minute. The extrusion apparatus comprises three temperature control zones, with the conditioned mixture being controlled to a temperature of from about 25° C. in the first zone, about 50° C. in the second zone, and about 80° C. in the third zone. The molten extrusion mass is subjected to a pressure of at least about 400 psig in the first zone up to about 1500 psig in the third zone. Water, 60 kg, is injected into the extruder barrel, via one or more injection jets in communication with a heating zone. The molten extruder mass exits the extruder barrel through a die assembly. As the extrudate exits the die assembly, it is cut with flexible knives and the cut mass is then dried to a moisture content of about 10% by weight.

### Example 3

### Application of Extruded Protein Composition Microwave-Ready Snacks

The present extruded protein composition can be expanded via heating by microwave oven and the resulted finish snacks had an aerated structure crisp and crunchy texture. The following example describes a complete formula of snacks. Flavor of the glazes may include peanut butter, chocolate, chocolate peanut butter, caramel, toffee, maple, butter pecan, brown sugar, Oreo®, cinnamon toast, vanilla, vanilla crème, butter, cheese, BBQ, ranch, etc.

Sample #1. Peanut Butter Flavored Microwave Puff Snacks:

Peanut butter flavored glaze formula:

| Ingredient | % | G |
|---|---|---|
| High Fructose corn syrup, 55% | 37.80 | 37.80 |
| Vegetable shortening | 10.80 | 10.80 |
| Granulated sugar | 16.20 | 16.20 |
| Creamy peanut butter | 32.40 | 32.40 |
| Peanut butter flavor | 2.16 | 2.16 |
| Caramel Color | 0.65 | 0.65 |
| Total | 100.00 | 100.00 |

Finished snack formula:

| Ingredient | % | g |
|---|---|---|
| Peanut butter flavored glaze | 50 | 20 |
| Extruded protein composition | 25 | 10 |
| Dry Roasted Peanuts or popcorn | 25 | 10 |
| Total | 100 | 40 |

Procedure:

Preparation of peanut butter flavored glaze: Mix sugar, shortening, corn syrup and peanut butter with a Hobart mixer at low speed for 2 minutes or until it becomes uniform. Add peanut butter flavor and caramel color and mix for additional 1 minute.

Mix peanut butter flavored glaze, extruded protein composition and dry roasted peanuts together till uniform. Weigh out 40 g and place it a microwave bag. Heat with microwave at high for 60 seconds.

Consume as is as snacks or mix with milk as cereals

Sample #2: Chocolate Peanut Butter Flavored Microwave Snacks

Moreover, the present protein composition can be expanded together with regular popcorn upon heating by microwave oven. Flavor of the glazes may include peanut butter, chocolate, chocolate peanut butter, caramel, toffee, maple, butter pecan, brown sugar, Oreo®, cinnamon toast, vanilla, vanilla crème, butter, cheese, BBQ, ranch, etc.

Chocolate peanut butter flavored glaze formula:

| Ingredient | G | % |
|---|---|---|
| High Fructose corn syrup, 55% | 37.80 | 37.80 |
| Vegetable shortening | 10.80 | 10.80 |
| Granulated sugar | 16.20 | 16.20 |
| Creamy peanut butter | 26.90 | 26.90 |
| Cocoa powder | 3.64 | 3.64 |
| Chocolate flavor | 2.50 | 2.50 |
| Peanutbutterflavor | 2.16 | 2.16 |
| Total | 100.00 | 100.00 |

Finished snack formula:

| Ingredient | g | % |
|---|---|---|
| Chocolate peanut butter flavored | 50 | 20 |
| glaze | | |
| Extruded protein composition | 25 | 10 |
| Roasted peanuts or Popcorn | 25 | 10 |
| Total | 100 | 40 |

Procedure:

Preparation of peanut butter flavored glaze: Mix sugar, shortening, corn syrup and peanut butter with a Hobart mixer at low speed for 2 minutes or until it becomes uniform. Add cocoa powder, chocolate flavor and peanut butter flavor and mix for additional 1 minute.

Mix peanut butter flavored glaze, extruded protein composition and popcorn together till uniform. Weigh out 40 g and place it a microwave bag. Heat with microwave at high for 60-90 seconds.

Consume as is as snacks or mix with milk as cereals

Ready-To-Eat (RTE) Snacks

The present extruded protein composition can be expanded via various methods, such as microwave oven, inferred oven, air impingement oven, and ovens using convection & conduction heating. Expanded snacks are described as protein puffs in the following formulas. The protein puff can be either coated with sugar based glaze, or be sprayed with oil and seasonings.

Sample #3: Peanut Butter Flavored RTE Snacks

| Ingredients | % |
|---|---|
| Granulated sugar | 33.44 |
| Granulated salt | 0.51 |
| Soy lecithin | 0.07 |
| Tap water | 5.66 |
| Corn syrup solids | 17.31 |
| (42DE) | |
| Caramel color | 0.20 |
| Butter-Unsalted | 7.31 |
| Peanut butter flavor | 0.50 |
| Protein Puffs | 35.00 |
| Total | 100.00 |

Procedure:

Mix all ingredients together except protein puffs and heat up the mixture to 275F with constant stirring.

Remove from heating and add protein puffs and stir until fully coated.

Spread onto lightly oil-sprayed aluminum foil.

Allow to cool and harden before packaging

Sample #4: Maple Butter Pecan Flavored RTE Snacks

| Ingredients | % |
|---|---|
| Granulated sugar | 33.44 |
| Granulated salt | 0.51 |
| Soy lecithin | 0.07 |
| Tap water | 5.66 |
| Corn syrup solids | 16.34 |
| (42DE) | |
| Caramel color | 0.05 |
| Butter Unsalted | 7.31 |
| Butter flavor | 0.1 |
| Butter pecan flavor | 0.02 |
| Maple flavor | 1.50 |
| Protein Puffs | 35.00 |
| Total | 100.00 |

Procedure:

Mix all ingredients together except protein puffs and heat up the mixture to 275 F with constant stirring.

Remove from heating and add protein puffs and stir until fully coated.

Spread onto lightly oil-sprayed aluminum foil.

Allow to cool and harden before packaging

Sample #5: Cinnamon Flavored RTE Snacks

| Ingredients | % |
|---|---|
| Granulated sugar | 33.44 |
| Granulated salt | 0.51 |
| Soy lecithin | 0.07 |
| Tap water | 5.66 |
| Corn syrup solids | 17.46 |
| (42DE) | |
| Caramel color | 0.05 |
| Butter-Unsalted | 7.31 |
| Ground cinnamon | 0.20 |
| Cinnamon toast flavor | 0.30 |
| Protein Puffs | 35.00 |
| Total | 100.00 |

Procedure:

Mix all ingredients together except protein puffs and heat up the mixture to 275 F with constant stirring.

Remove from heating and add protein puffs and stir until fully coated.

Spread onto lightly oil-sprayed aluminum foil.

Allow to cool and harden before packaging

Sample #6: Chocolate Flavored RTE Snacks

| Ingredients | % |
|---|---|
| Granulated sugar | 32.09 |
| Granulated salt | 0.51 |
| Soy lecithin | 0.07 |
| Tap water | 5.66 |
| Corn syrup solids | 17.31 |
| (42DE) | |
| Caramel color | 0.35 |
| Butter-Unsalted | 6.31 |
| Chocolate liquor | 2.00 |
| Chocolate flavor | 0.70 |
| Protein Puffs | 35.00 |
| Total | 100.00 |

Procedure:

Mix all ingredients together except protein puffs and heat up the mixture to 275 F with constant stirring.

Remove from heating and add protein puffs and stir until fully coated.

Spread onto lightly oil-sprayed aluminum foil.

Allow to cool and harden before packaging

Sample #7: Cheese Flavored RTE Snacks

| Ingredient | % |
|---|---|
| Protein puffs | 82 |
| Vegetable oil | 8 |
| Savory seasonings | 10 |
| Total | 100 |

Savory seasonings: Cheese, Ranch, BBQ, etc.

Process:

Coat protein puffs by spraying oil inside a tumbler

Apply seasoning simultaneous till uniform coating is achieved.

Hot Cereals

Sample #8:

| Ingredient | % |
|---|---|
| Extruded protein | 20 |
| composition* | |
| Rolled oats | 20 |
| Low fat milk (1%) | 60 |
| Total | 100 |

Preferably in flake shapes

Process:

Place the extruded protein composition in a bowl and microwave at high for 1 min

Add rolled oats (or quick oats) and 1% milk and mix well. Heat at high for another 1 min

Ready to consume

Examples of Pellet Formulations:

### Example 9

High Protein Pellets

| Ingredient | Sample A | Sample B | Sample C | Sample D |
|---|---|---|---|---|
| Supro ® 710, | 25% | | | |
| Soy Protein Isolate | | | | |
| Supro ® 313, | | 25% | | |
| Soy Protein Isolate | | | | |
| Supra ® 8000, | | | 25% | |
| Soy Protein Isolate | | | | |
| Supra ® 620, | | | | 25% |
| Soy Protein Isolate | | | | |
| Tapioca | 75% | 75% | 75% | 75% |
| Expansion Ratio | 3.9:1 | 6.6:1 | 6.2:1 | 3.4:1 |
| (puff vs. pellet) | | | | |

The mixtures of the above were extruded using a Wenger TX-52 Mag twin-screw extruder with a 19:1 l/d barrel with a vent port open to ambient pressure through a 3 mm diameter die with 6 openings. The above formulations were preconditioned by injecting 20% moisture additional by weight and adding steam to bring the conditioner's discharge temperature from about 20° C. to about 50° C. as it enters the extruder barrel. The extruder barrel consisted of three processing sections: cooking, venting, and cooling. The temperature profile set points were: cooking sections 75° C. and 100° C., venting and cooling sections 20° C. The typical feed rate of the above formulation ranged from 25 kg/hr to 35 kg/hr, with a calculated specific mechanical energy from about 40 kWh/ton to 65 kWh/ton. The expansion ratio was measured by comparing the displacement of salt (granulation −20 to +60) of dried extruded pellets and the same pellets microwave puffed.

### Example 10

High Protein Pellets with High Fiber

| Ingredient | Sample A | Sample B | Sample C | Sample D |
|---|---|---|---|---|
| Supro ® 710, | 19 | | | |
| Soy Protein Isolate | | | | |
| Supra EX45, Soy Protein | | 19 | | |
| Isolate | | | | |
| Supro ® 313, | | | 19 | |
| Soy Protein Isolate | | | | |
| Supro ® 620, | | | | 19 |
| Soy Protein Isolate | | | | |
| Fibrim ® 1260, | 18.5 | 21 | 18.5 | 20 |
| Soy Fiber | | | | |
| Fibrim ® 2000, | 2.5 | | 2.5 | 1 |
| Soy Fiber | | | | |
| Tapioca | 60 | 60 | 60 | 60 |
| Expansion Ratio | 3.5:1 | 2.1.1 | 7.6:1 | 3.6:1 |
| (puff vs. pellet) | | | | |

The mixtures of the above were extruded using the conditions disclosed in Example 9. The expansion ratio was measured by comparing the displacement of salt (granulation −20 to +60) of dried extruded pellets and the same pellets microwave puffed.

### Example 11

High Protein, High Fiber Pellets with various starches

| | Sample | Sample | Sample | Sample | Sample | Sample |
|---|---|---|---|---|---|---|
| Ingredient | A | B | C | D | E | F |
| Supro ® | 19 | 19 | 19 | 19 | 19 | 19 |
| 8000, Soy | | | | | | |
| Protein Isolate | | | | | | |
| Fibrim ® | 21 | 21 | 21 | 21 | 21 | 21 |
| 2000, Soy | | | | | | |
| Fiber | | | | | | |
| Rice Flour, | 60 | | | | | |
| long grain | | | | | | |
| Potato Flour | | 60 | | | | |
| Yellow Corn | | | 60 | | | |
| Flour | | | | | | |
| Whole Corn | | | | 60 | | |
| Flour | | | | | | |
| Semolina Flour | | | | | 50 | |
| Tapioca | | | | | 10 | 60 |
| Expansion | 0.7:1 | 1.6:1 | 2.1:1 | 3.3:1 | 3.4:1 | 3.8:1 |
| Ratio (puff | | | | | | |
| vs. pellet) | | | | | | |

The mixtures of the above were extruded using the conditions disclosed in Example 9. The expansion ratio was measured by comparing the displacement of salt (granulation −20 to +60) of dried extruded pellets and the same pellets microwave puffed.

What is claimed is:

1. An extruded protein composition comprising a density of between about 0.3 g/cm³ to about 1.5 g/cm³ and protein matrices that have a substantially closed cell structure.

2. The extruded protein composition of claim 1, wherein the extruded protein composition has a protein concentration of at least about 20% by weight.

3. The extruded protein composition of claim 2, wherein the extruded protein composition comprises a starch selected from the group consisting of rice flour, rice starch, potato starch, tapioca, wheat starch, corn starch, and mixtures thereof.

4. The extruded protein composition of claim 3, wherein the extruded protein composition has a starch concentration of at least about 20% by weight.

5. The extruded protein composition of claim 3, wherein the ratio of starch to protein present in the extruded protein composition is from about 4:1 to about 1:4 by weight.

6. The extruded protein composition of claim 1, wherein the protein is derived from a source selected from the group consisting of an animal protein, a plant protein, and mixtures thereof.

7. The extruded protein composition of claim 6, wherein the plant protein is derived from a plant selected from the group consisting of legumes, oilseeds, cereal grains, tubers, pseudograins, and mixtures thereof.

8. The extruded protein composition of claim 6, wherein the plant protein comprises soybean protein and wheat protein; and the starch is tapioca.

9. The extruded protein composition of claim 6, further comprising an ingredient selected from the group consisting of a vitamin, a mineral, an antioxidant, a dietary fiber, an herb, a flavoring agent, a coloring agent, and mixtures thereof.

10. An expanded extruded protein composition comprising the extruded protein composition of claim 1, wherein the extruded protein composition of claim 1 is heated to at least about 100° C. to yield an expanded extruded protein composition having a density of less than about 0.3 g/cm³.

11. A food product comprising:
(a) an extruded protein composition comprising a density of between about 0.3 g/cm³ to about 1.5 g/cm³ and protein matrices that have a substantially closed cell structure; and
(b) a food ingredient.

12. The food product of claim 11, wherein the extruded protein composition has a protein concentration of at least about 20% by weight.

13. The food product of claim 12, wherein the extruded protein composition comprises a starch selected from the group consisting of rice flour, rice starch, potato starch, tapioca, wheat starch, corn starch, and mixtures thereof.

14. The food product of claim 13, wherein the extruded protein composition has a starch concentration of at least about 20% by weight.

15. The food product of claim 14, wherein the protein is derived from a plant selected from the group consisting of legumes, oilseeds, cereal grains, tubers, pseudograins, and mixtures thereof.

16. The food product of claim 11, wherein the food ingredient is selected from the group consisting of popcorn, cereal, nuts, granola, pretzels, trail mix, crackers, potato chips, tortilla chips, and pork rinds.

17. The food product of claim 16, wherein the ratio of food ingredient to extruded protein composition present in the food product is from about 4:1 to about 1:4 by weight.

18. The food product of claim 17, further comprising an ingredient selected from the group consisting of a flavoring agent, a coloring agent, and mixtures thereof.

19. A process for producing an extruded protein composition, the process comprising:
(a) combining a protein-containing material with a starch to form a mixture; and
(b) extruding the mixture under conditions of elevated temperature and pressure to form an extruded protein composition, the extruded protein composition comprising a density of between about 0.3 g/cm³ to about 1.5 g/cm³ and protein matrices that have a substantially closed cell structure.

20. The process of claim 19, wherein the extruded protein composition has a protein concentration of at least about 20% by weight.

21. The process of claim 20, wherein the extruded protein composition comprises a starch selected from the group consisting of rice flour, rice starch, potato starch, tapioca, wheat starch, corn starch, and mixtures thereof.

22. The process of claim 21, wherein the extruded protein composition has a starch concentration of at least about 20% by weight.

23. The process of claim 21, wherein the ratio of starch to protein present in the extruded protein composition is from about 4:1 to about 1:4 by weight.

24. The process of claim 23, wherein the protein is derived from a source selected from the group consisting of an animal protein, a plant protein, and mixtures thereof.

25. The process of claim 23, wherein the plant protein is derived from a plant selected from the group consisting of legumes, oilseeds, cereal grains, tubers, pseudograins, and mixtures thereof.

26. The process of claim 19, wherein the plant protein comprises soybean protein and wheat protein; and the starch is tapioca.

27. The process of claim 25, further comprising an ingredient selected from the group consisting of a vitamin, a mineral, an antioxidant, a dietary fiber, an herb, and mixtures thereof.
